(19) United States
(12) Patent Application Publication
(10) Pub. No.: US 2007/0033591 A1
(43) Pub. Date: Feb. 8, 2007

(54) System and method for schedule quality assessment

(75) Inventors: Warren J. Kline, Sachse, TX (US); Diane M. McCrea, Moshannon, PA (US); Lora J. Clark, Frisco, TX (US); Charisse A. McLorren, Allen, TX (US); Jean M. Hagar, Carrollton, TX (US); Darrell K. Henson, Dallas, TX (US)

Correspondence Address: BAKER BOTTS LLP, 2001 ROSS AVENUE, 6TH FLOOR, DALLAS, TX, 75201, US

(73) Assignee: Raytheon Company

(21) Appl. No.: 11/185,225

(22) Filed: Jul. 19, 2005

(51) Int. Cl. G06F 9/46

(52) U.S. Cl. 718/102

(57) ABSTRACT

According to one embodiment, a method for evaluating schedule data is provided that includes filtering schedule data to identify a grouping of records. The grouping of records is associated with a measurable parameter. At least one reportable parameter indicative of the quality of the schedule data is calculated for the grouping of records. A qualitative assessment of the schedule data is performed based upon the calculation of the at least one reportable parameter.

### FIELD OF INVENTION

The present invention relates generally to scheduling and more particularly to a system and method for schedule quality assessment.

### BACKGROUND OF THE INVENTION

Project management is the application of knowledge, skills, tools, and techniques to plan and manage activities to meet or exceed stakeholder expectations. A critical tool used to achieve this end includes the schedule. Programs such as Microsoft Project may be used to capture and maintain a project schedule into a schedule database. Schedules generated using Microsoft Project and other similar tools operate to calendarize and connect all the discrete tasks necessary to complete the work of a program or project successfully. Many factors, however, contribute to the structural integrity of a schedule and must be manually evaluated for the identification of schedule weaknesses. The analysis and evaluation of a schedule slows the implementation and execution of that schedule and impedes the ability of managers to assess the effectiveness and efficiency of the schedule.

### SUMMARY OF THE INVENTION

According to one embodiment, a method for evaluating schedule data is provided that includes filtering schedule data to identify a grouping of records. The grouping of records is associated with a measurable parameter. At least one reportable parameter indicative of the quality of the schedule data is calculated for the grouping of records. A qualitative assessment of the schedule data is performed based upon the calculation of at least one reportable parameter.

Certain examples of the invention may provide one or more technical advantages. A technical advantage of one exemplary embodiment of the present invention is that a database management and analysis system is provided that allows for the automated analysis of raw schedule data. In particular, measurable parameters may be identified for evaluating the structural and qualitative characteristics of schedule data. For example, statistical percentage calculations may be determined from vast amounts of raw schedule data. The statistical percentages obtained may be compared to threshold and benchmark values for the structural and qualitative assessment of a schedule. Another technical advantage may be that reports and summaries may be generated for display to users implementing and evaluating a schedule. As still another technical advantage, the raw schedule data and analyzed data may be stored in a manner that may be easily manipulated.

Other technical advantages may be readily apparent to one skilled in the art from the figures, descriptions and claims included herein. None, some, or all of the examples may provide technical advantages.

### BRIEF DESCRIPTION OF THE DRAWINGS

For a more complete understanding of the present invention and its features and advantages, reference is now made to the following description, taken in conjunction with the accompanying drawings, in which like reference numerals refer to like elements, and wherein:

FIG. 1 is a block diagram of a system for the analysis of schedule data;

FIGS. 2A and 2B are example screen shots for displaying analyzed schedule data to a user; and

FIG. 3 is a flowchart of a method for the analysis of schedule data.

### DETAILED DESCRIPTION OF THE INVENTION

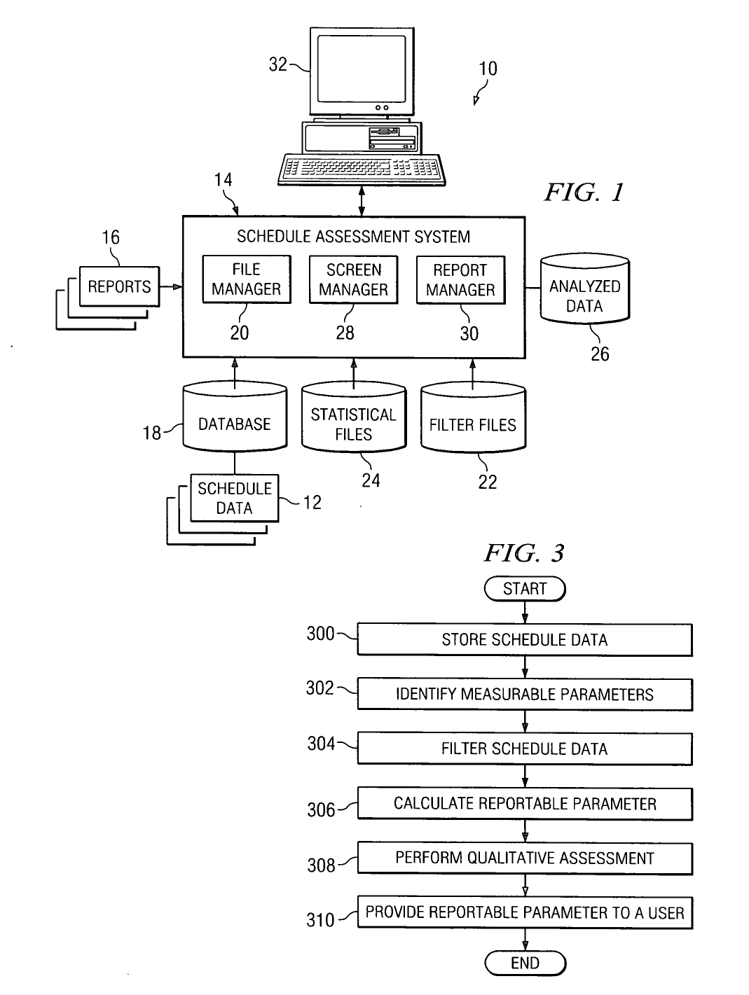

FIG. 1 is a block diagram of a system 10 for the structural and qualitative assessment of schedule data 12. Schedule data 12 includes a schedule plan for performing work or achieving an objective. The schedule may include tasks, summaries, milestones, timelines, and/or other project events that may, in particular embodiments, be linked to one another. In particular embodiments, schedule data 12 may specify the order of such tasks, summaries, milestones, and other scheduled events and an allotted time for each item. Additionally, schedule data 12 may include participant information identifying those persons or entities that are responsible or otherwise involved in the performance of scheduled events within the schedule. For the analysis of such schedule data 12, system 10 includes a Schedule Assessment System (SAS) 14 that uses a recognized set of measurable parameters to assess the qualitative and structural integrity of a schedule. In particular embodiments, SAS 14 may operate to filter, parse, group, summarize, count, and manage schedule data 12 such that potential qualitative and structural weaknesses in the schedule data 12 are identified in an automated manner.

Schedule data 12 may include project data that is generated and/or managed by a scheduling software program. In particular embodiments, SAS 14 may operate independently of the schedule generating software or program. For example, schedule data 12 may be generated and/or managed by Artemis offered by Artemis International Solutions Corporation, Primavera Project Planner offered by Primavera Systems, Inc., or Microsoft Project offered by Microsoft Corporation. In other embodiments, SAS 14 may form a portion of the schedule generating software or program. Schedule data 12 that is generated by SAS 14 or received and managed by SAS 14 may be stored in a schedule database 18 that is accessible to SAS 14. Accordingly, SAS 14 may then receive or extract schedule data 12 from schedule database 18 for the purposes of assessing the organization and quality of schedule data 12.

A filter manager 20 that includes a computing device or other processor with the appropriate software and functionality for managing schedule data 12 may access schedule database 18 for the qualitative assessment of schedule data 12. In particular embodiments, filter manager 20 may include any combination of macros and visual basic programming that allows schedule data 12 to be parsed and evaluated. In parsing schedule data 12, filter manager 20 may operate to sort through the raw schedule data 12 to identify measurable parameters organized in layers of information. Additionally or alternatively, filter manager 20 may perform navigation functions, selection functions, grouping functions, or any appropriate combination of these or other data management functions.

In particular embodiments, filter manager 20 may operate to communicate with schedule database 18 and other system components to obtain inputs and parameters for the qualitative assessment of schedule data 12. For example, filter manager 20 may operate to extract schedule data 12 from schedule database 18. Filter manager 20 may then apply one or more diagnostic filters to schedule data 12. In particular embodiments, diagnostic filters may be used by filter manager 20 to identify measurable parameters that are indicative of the integrity of a given schedule corresponding to schedule data 12. Thus, in particular embodiments, filter manager 20 may also operate to extract diagnostic filter files from filter file database 22 for application to schedule data 12.

Generally, a satisfactory schedule may track top-level program objectives, organize all required tasks logically, be timely and accurate, provide summary program metrics, and enable predictive course correction. A schedule may also enable “what if” analysis, provide clear task definitions and realistic time spans, define the interfaces between functions or teams, and provide the program team with a basis for informed management decisions. To achieve these and other scheduling objectives, a schedule may be developed using the following set of tenets:
1. The schedule should be primarily made up of discrete tasks that are associated with the performance of work. Summaries and Milestones, which are not typically associated with the performance of work, are needed for reporting and tracking purposes but should not comprise the majority of the line items in a schedule.
2. The percentage of the program/project completed should be continually or periodically monitored since it is generally recognized that the closer a program/project is to complete the less the final outcome can be influenced.
3. With the exception of starting and ending tasks/milestones, the events within a schedule should have a predecessor and successor. Examples of starting and ending tasks/milestones include authorization to proceed and end item deliverables to outside parties.
4. Summaries should not have predecessors or successors to avoid difficulties in calculating dates and critical paths due to linkages between summary tasks and detail tasks.
5. Task durations should be between five and twenty working days since too much detail can make the schedule unreadable, un-maintainable, and unusable as a management tool and too little detail can make the schedule little more than window dressing. Sufficient detail must exist to clearly identify all the key handoffs and must contain enough information to identify what state the program/project is in at any given point in time. Near term tasks should be a week to a month in length.
6. Schedule progress should drive the end dates of the program/project. Accordingly, tasks that are incomplete should be scheduled forward to provide for a true picture of the program/project status and projected end date.
7. Lag should be used sparingly and should be well documented. Lags can hide the true state of a schedule and misdirect the critical path.
8. Tasks should not be artificially tied to dates. Durations and/or resources combined with schedule logic and calendars should determine schedule dates. If a significant number of constrained dates are used the schedule may not calculate the critical path and near critical paths correctly.
9. All schedules should establish baseline dates for every task and milestone in the schedule early in the program/project. Typically the customer and the contract require this to be done within sixty to ninety days of the start and prior to a formal integrated baseline review.
10. A resource loaded schedule should have resources assigned to all discrete tasks and should not have resources assigned to summary tasks. Resource planning requires that all discrete tasks be resource loaded in order to analyze and identify resource constraints or over loaded resources.
11. All schedules should have a reasonably small amount of float or slack. Large positive or negative amounts of float or slack indicate a poorly constructed schedule. Specifically, a large amount of negative float indicates a logic error or a schedule that is no longer on track to meet its commitment dates. In contrast, a large amount of positive float indicates poor logic or missing logic.
12. The majority of the linkages should be “Finish-to-Start” (FS). Since most of the tasks represent work that will result in some product or document that is needed by someone else, the work is generally performed serially. If the majority of the tasks require parallel linkages the tasks may be at too high of a level.
13. The critical path should be the most difficult, time-consuming, and technically challenging portion of the schedule. It should represent a small portion of the overall schedule.
14. Although most programs/projects fall behind schedule during normal execution, a program/project should not operate for a significant period of time with a large amount of negative float. Recovery plans or workarounds should be identified and implemented. If none are feasible, then a re-programming should be done to define a plan that can be executed and agreed to.
15. All tasks should have a Work Breakdown Structure (WBS) assigned. The WBS is the key to cost schedule integration. A missing WBS gives the appearance of work being done that is not within the budget or scope of the program. Level of Effort (LOE) tasks do not need to be in a schedule since they add little value to measuring progress and may interfere with the calculation of the schedule's true critical path and near critical paths.
16. Actual dates must reflect when a task started or completed. They should not be auto generated and should not exist in the future. An actual finish date cannot be earlier than the actual start date for a task.

Although a schedule that adheres to the above listed tenets is not necessarily efficient, effective, or otherwise qualitatively satisfactory, the tenets may be helpful in the assessment of a schedule in many instances. Accordingly, the diagnostic filters stored in filter files database 22 and applied by filter manager 20 may be designed to identify features within the schedule that correspond with the above listed tenets.

In particular embodiments, the application of a diagnostic filter to schedule data 12 by filter manager 20 may result in one or more counts of identifiable features within the schedule data 12. For example, the application of diagnostic filters to schedule data may render one or more of the following counts:
Number of Records
Number of Tasks
Number of Summaries
Number of Milestones
Number of Incomplete Tasks
Number of Tasks/Milestones without Successors
Number of Tasks/Milestones with Predecessors
Number of Summaries with Successors
Number of Summaries with Predecessors
Number of Tasks with Duration <5 days
Number of Tasks with Duration >20 days
Number of Tasks/Milestones not Scheduled Forward
Number of Tasks with Lag >30 days
Number of Tasks/Milestones that are not “As Soon as Possible”
Number of Incomplete Tasks/Milestones without Baseline Finish
Number of Incomplete Tasks without Resources
Number of Incomplete Tasks with Total Float <−20 days
Number of Incomplete Tasks with Total Float >30 days
Number of Incomplete Tasks with Total Float >200 days
Number of Tasks/Milestones with Predecessors Not FS
Number of Incomplete Critical Tasks
Number of Incomplete Tasks with Total Float <−200 days
Number of Tasks/Milestones without WBS
Number of LOE Tasks
Number of Tasks/Milestones not Started with Predecessors 100%
Number of Tasks with Actual Start/Finish Dates in the future
Number of Tasks with Actual Finish earlier than Actual Start
Number of Summaries with Resources

Upon obtaining the counts, filter manager 20 may, in particular embodiments, perform calculations on the counts to obtain statistics percentages relating to each measured parameter. For example, assume that filter manager 20 determines that a particular schedule includes twenty tasks, four summaries, and four milestones (a total of twenty-eight records). As described above, it is generally recognized that a satisfactory schedule is primarily made up of discrete tasks rather than summaries and milestones. Accordingly, filter manager 20 may perform simple percentage calculations on the counts to assess the structural integrity of the schedule data 12. In the above described example, filter manager 20 may determine that 71.4% of the records comprise tasks, that 85.7% of the records are not summaries, and that 85.7% of the records are not milestones.

For the further analysis of the counts, filter manager 20 may compare the counts and/or the statistical percentages to one or more statistics files that are stored in a statistics database 24. A statistics file may identify one or more threshold values that may be used as a check of the measured parameter corresponding with a count. In particular embodiments, the threshold values may be determined by applying statistical analysis techniques to one or more schedules of a known level of quality. For example, assume that a statistical analysis of a grouping of six schedules known to be satisfactory results in a determination that, on average, tasks comprise seventy percent of the records in the known satisfactory schedules. Thus, seventy percent may generally be used as a threshold value for identifying a “satisfactory” or “good” schedule based upon the ratio of tasks to records. Accordingly, if the count identifying the percentage of tasks in schedule data 12 is determined to be above the threshold value of seventy percent, filter manager 20 may determine that the given schedule is “satisfactory” or “good” with respect to this measurable parameter. Conversely, if a count of the percentage of tasks for schedule data 12 is determined to be below the threshold value of seventy percent, filter manager 20 may determine that the schedule has potential or probable weaknesses.

Once schedule data 12 is analyzed to assess the quality of a given schedule with respect to the one or more measurable parameters, SAS 14 may store the analyzed test data in an analyzed data database 26. Additionally, because the value of the analyzed data may not be appreciated until it is presented to and received by a user, SAS 14 may include a screen manager 28 and/or a report manager 30, which may collectively or alternatively operate to report the analyzed data to a user. The user may then react to the analyzed data by implementing a schedule that is deemed satisfactory or by revising a schedule that is deemed unsatisfactory.

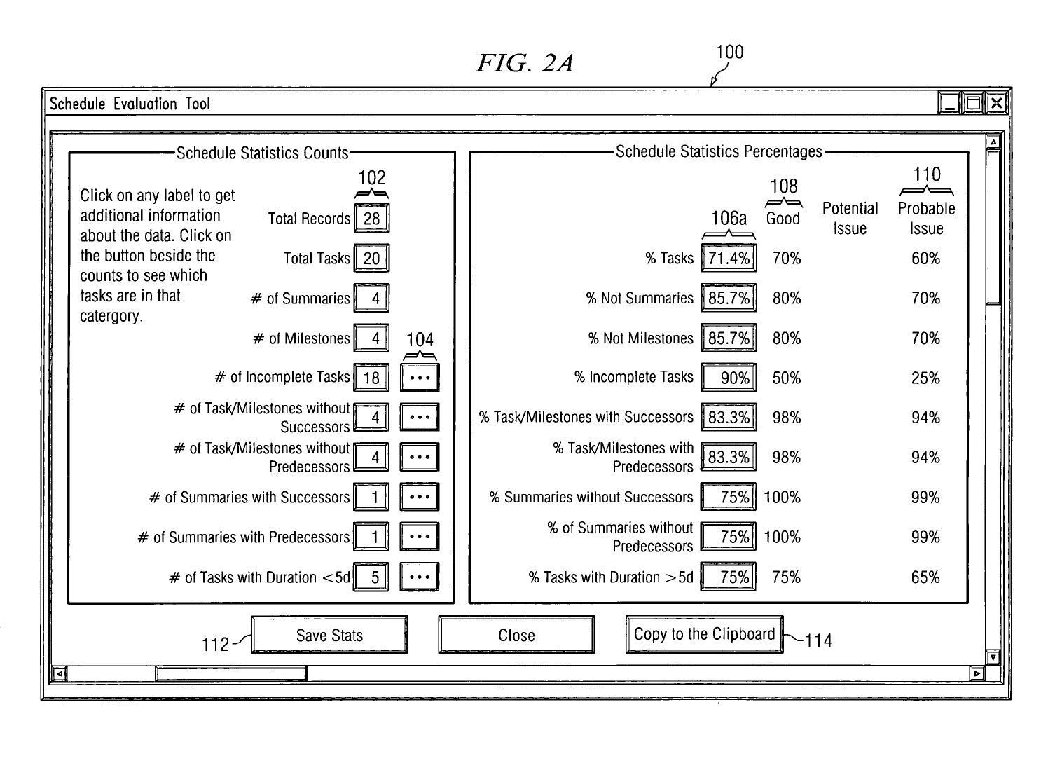

Specifically, screen manager 28 may communicate the analyzed data to a graphical user interface (GUI) 32 associated with SAS 14 or another computing system. In particular embodiments, the analyzed data may be displayed to the user in the form of screen shots. An example of such screen shots are illustrated in FIGS. 2A-2B. Specifically, FIG. 2A illustrates a screen shot 100 that includes a summary of counts 102 for schedule data 12. Although the statistical counts 102 in the illustrated example correspond generally with the list of measurable parameters listed above, it is generally recognized that counts 102 are merely example parameters that may be of consideration in the evaluation of a schedule. Any combination of these or other measurable parameters may be evaluated and displayed to a user on GUI 32.

In the illustrated embodiment, screen shot 100 includes filtered view buttons 104. When selected by a user, a filtered view button 104 may result in a filtered screen shot, such as filtered screen shot 200 illustrated in FIG. 2B, being displayed on GUI 32. In particular embodiments, filtered screen shot 200 may summarize only those records that are included in a count 102 for a measurable parameter. Accordingly, and as illustrated in filtered screen shot 200, if filter manager 20 determines that schedule data 12 includes four records corresponding to tasks or milestones without predecessors, filtered screen shot 200 may include only those four records.

Returning to FIG. 2A, screen shot 100 includes one or more statistical percentages 106 calculated from counts 102. Statistical percentages 106 provide information that may be used to compare the evaluated schedule with other schedules for quality assessment. In the illustrated embodiment, screen shot 100 includes statistical percentages 106 corresponding with the following twenty-seven measurable parameters:
% Tasks
% Not Summaries
% Not Milestones
% Incomplete Tasks
% Tasks/Milestones with Successors
% Tasks/Milestones with Predecessors
% Summaries without Successors
% Summaries without Predecessors
% Tasks with Duration >5 days
% Tasks with Duration <20 days
% Tasks/Milestones Scheduled Forward
% Tasks with Lag <30 days
% Tasks/Milestones that are “As Soon as Possible”
% Incomplete Tasks/Milestones with Baseline Finish
% Incomplete Tasks without Resources
% Incomplete Tasks with Total Float >−20 days
% Incomplete Tasks with Total Float <30 days
% Incomplete Tasks with Total Float <200 days
% Tasks/Milestones with Predecessors FS
% Completed Non-Critical Tasks
% Incomplete Tasks with Total Float >−200 days
% Tasks/Milestones with WBS
% Tasks Not LOE
% Tasks/Milestones Started with Predecessors
% Tasks with Actual Start/Finish Dates in the past
% Tasks with Actual Finish later than Actual Start
% of Summaries without Resources
   It is generally recognized, however, that the statistical percentages 106 illustrated in screen shot 100 are merely provided as examples of statistical measures that may be evaluated and displayed to a user on GUI 32.

For the evaluation of statistical percentages 106, screen shot 100 includes threshold values 108 and 110. As described above, a threshold value 108 or 110 may be used as a check of a measured parameter. Specifically, a threshold value 108 or 110 corresponding to a given measurable parameter may be compared to the statistical percentage 106 calculated by filter manager 20. The comparison may allow filter manager to identify the relative quality of the schedule with respect to the measured parameter. For example, in particular embodiments, a threshold value 108 may identify a minimum value by which the schedule data 12 may be determined to be satisfactory with respect to the particular measurable parameter. Additionally or alternatively, a threshold value 110 may identify a value at which it is determined that a schedule is more likely to include weaknesses. Accordingly, if, as illustrated in screen shot 100, it is determined that the records within a schedule are comprised of 71.4% of tasks and the first threshold value 108 is seventy percent, schedule data 12 may be considered “satisfactory” or “good” with respect to this measurable parameter. Conversely, schedule data 12 that is determined to be comprised of less than 60% of tasks may be determined to have probable issues that may affect the integrity of the schedule data 12. A schedule comprised of between 60% and 70% of tasks may be determined to have potential issues.

In particular embodiments, the quality of the evaluated schedule data 12 with respect to each measurable parameter may be identified to the user of screen shot 100 using color-coding. For example, where the statistical percentage 106 for a measurable parameter is determined by filter manager 20 to be “good,” the statistical percentage 106 corresponding to the measurable parameter may be colored in a first color, such as green. A user of screen shot 100 may recognize a green statistical percentage 106 as being indicative of a structurally and qualitatively sound schedule. Conversely, a statistical percentage 106 for a measurable parameter that is determined to be below the probable issue values may be colored in a second color, such as red, and a statistical percentage 106 that is falling in between the two threshold value, may be colored in a third color, such as yellow. A user of screen shot 100 may recognize a statistical percentage 106 colored in red or yellow as being indicative of probable or potential issues, respectively.

In the illustrated embodiment, screen shot 100 includes a “save stats” button. When the “save stats” button 112 is selected by a user of GUI 32, filter manager 20 may operate to save the data summarized on screenshot 100 in an analyzed data database 26 or another database associated with SAS 14. In particular embodiments, the schedule data illustrated in screen shot 100 may be automatically converted into an appropriate format before it is saved in analyzed data database 26. For example, the schedule data may be automatically converted into an excel spreadsheet or other data sheet and saved in the appropriate file format. Also for the conversion of schedule data, screen shot 100 may additionally or alternatively include a “copy to the clipboard” button 114 that may similarly result in the conversion of the evaluated schedule data to a format that may allow for manipulation by the user.

Returning to FIG. 1, whereas screen manager 28 displays the analyzed data on GUI 32, report manager 30 may operate to generate a hard copy of the analyzed data, or publish a web-publication with a set of reports hyper-linked with web-publication language and format. For example, report manager 30 may include or be in communication with a printer that generates a hard copy of reports 16. In particular embodiments, reports 16 may include information that is similar to screen shots 100 and 200 of FIGS. 2A and 2B, respectively. Thus, reports 16 may include tabular or graphical representations of the analyzed schedule data. Because reports 16 are generated as hard copies, reports 16 may be distributed or circulated as appropriate for user analysis of the analyzed schedule data.

Reports 16 and screen shots 100 and 200 provided to the user may be periodically updated. Thus, as new schedule data is received by SAS 14, screen shots 100 and 200 and reports 16 generated by screen manager 28 and report manager 30, respectively, may be updated. For example, when a schedule is revised and/or new schedule data 12 is obtained and stored in database 18, SAS 14 may extract the new schedule data 12 and add the new schedule data 12 to analyzed data 26. The new schedule data may be integrated with the old schedule data to generate updated screen shots 100 and 200 and reports 16. Screen manager 28 and/or report manager 30 may then provide the user with updated screen shots 100 and 200 and reports 16, respectively. As another example, diagnostic filters stored in filter files database 22 may be updated or revised to include additional information for measuring the quality of schedule data 12. As new information is received by filter manager 20, filter manager 20 may automatically update analyzed data 26 to incorporate this information.

Although an exemplary configuration of system 10 is described, it is recognized that system 10 may include any appropriate number of components and databases. For example, although SAS 14 is illustrated as including a filter manager 20, a screen manager 28, and a report manager 30, it is contemplated that SAS 14 may include a single processor for performing the functions described above. Additionally, although system 10 is described as including a variety of databases for storing input files, raw schedule data, and analyzed schedule data, it is generally recognized that the schedule data and other files and information described above may be stored in any appropriate storage system and need not be stored separately.

Additionally, it is recognized that the content and organization of reports 16 and screen shots 100 and 200 are provided only as example configurations that may be utilized by SAS 14 to summarize analyzed schedule data. The content and scope of the analyzed data may include any appropriate information for providing meaningful views of qualitative schedule information to the many different interested parties. For example, it is recognized that a broader view may be more useful to a program/project manager than a more focused view, which may be more appropriately displayed to parties responsible for the performance of discrete tasks. Accordingly, many modifications may be made to system 10 without departing from the spirit and scope of the present invention

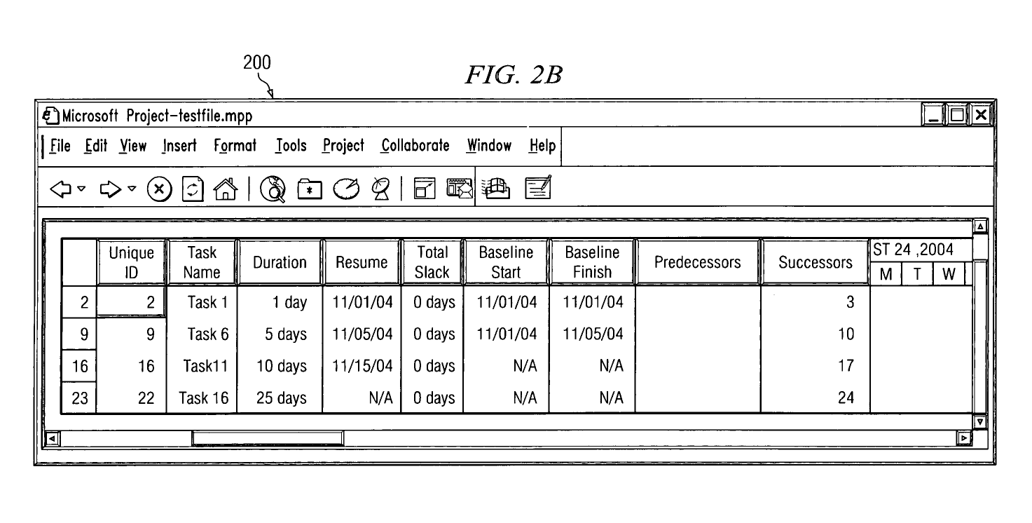

FIG. 3 is a flowchart of a method for the evaluation of schedule data 12. At step 300, schedule data 12 is stored in a schedule database 18. Schedule data 12 may comprise one or more schedules that includes a plurality of records. In particular embodiments, each record within a schedule may include a task, milestone, summary, or other scheduled event.

At step 302, measurable parameters may be identified. In particular embodiments, the measurable parameters may be identified by filter manager 20, which operates to apply one or more diagnostic filters stored in a filter files database 22 to schedule data 12 at step 304. Examples of measurable parameters that may be identified by the diagnostic filters are discussed above with regard to FIG. 1. Generally, the measurable parameters are indicative of the effectiveness, efficiency, structural integrity, or other qualitative characteristics of schedule data 12. In particular embodiments, the application of the diagnostic filters to schedule data 12 may result in groupings of records within schedule data 12 that correspond generally with the measurable parameters. For example, where a measurable parameter includes the number of tasks in a given schedule, an application of a diagnostic filter associated with this measurable parameter may result in a grouping of records that include all discrete tasks to be completed during the implementation of the schedule.

At step 306, a reportable parameter is calculated. In particular embodiments, calculating the reportable parameter may include performing a count of the number of records in a grouping of records identified by the application of a diagnostics filter to schedule data 12. Additionally, one or more calculations may be performed to obtain a statistically representative measure of the features within the schedule. For example, if a diagnostics filter is applied to determine that a schedule includes twenty-eight records and that four of the records comprise discrete tasks, filter manager 20 may determine that 71.4% of the records within the schedule comprise discrete tasks.

A qualitative assessment of the schedule data 12 may be performed at step 308. For example, in particular embodiments, the at least one reportable parameter calculated in step 306 may be compared to a threshold value. As described above with regard to FIG. 1, a threshold value may be used as a check of the measured parameter. In particular embodiments, a threshold value is determined using statistical analysis techniques applied to one or more schedules known to be structurally sound and/or of a desirable quality level. Based upon the comparison of the reportable parameter to the threshold value, the schedule associated with schedule data 12 may be assigned a quality level rating.

At step 310, the reportable parameter is provided to a user. In particular embodiments, the reportable parameter may be displayed to a user on GUI 32 or other display system. Additionally or alternatively, a hard copy 16 of the reportable parameter may be generated and provided to the user and/or the results may be made available as a web publication. As described above, with regard to FIGS. 2A and 2B, the information provided to the user may include high-level views and low-level views of the different layers of calculations. Tabular or graphical representations, such as charts, tables, graphs, and other figures, of the analyzed data may be presented to the user for further analysis of the schedule data 12.

Thus, the system and method described may provide certain technical advantages. For example, a database management and analysis system may be provided that allows for the automated analysis of raw schedule data. In particular embodiments, measurable parameters may be identified for evaluating the structural and qualitative characteristics of a schedule. For example, statistical percentage calculations may be determined from vast amounts of raw schedule data. The statistical percentages obtained may be compared to threshold and benchmark values for the structural and qualitative assessment of a schedule relative to other schedules of known quality levels. Additionally or alternatively, reports and summaries may be generated for display to users for further evaluation of a schedule.

Modifications, additions, or omissions may be made to the method without departing from the scope of the invention. The method may include more, fewer, or other steps. Additionally, steps may be performed in any suitable order without departing from the scope of the invention. Furthermore, although the present invention has been described in detail, it should be understood that various changes, alterations, substitutions, and modifications can be made to the teachings disclosed herein without departing from the spirit and scope of the present invention which is solely defined by the appended claims.

What is claimed is:

1. A method of evaluating schedule data, comprising:
filtering schedule data to identify a grouping of records, the schedule data comprising a plurality of tasks, at least one milestone, and at least one summary, each grouping of records associated with a measurable parameter;
performing a count for each grouping of records to calculate at least one reportable parameter indicative of the quality of the schedule data for the grouping of records;
comparing the at least one reportable parameter to at least one corresponding threshold value to perform a qualitative assessment of the schedule data based upon the calculation of the at least one reportable parameter, the at least one corresponding threshold value calculated based on the measurable parameter as applied to a grouping of a plurality of schedules of a known quality level;
assigning a rating to the at least one reportable parameter; and
providing the at least one reportable parameter to a user.
wherein the measurable parameter is selected from a group consisting of:
number of records comprising an incomplete task,
number of records with a predecessor,
number of records with a duration of less than a predetermined amount of time,
number of incomplete records without resources,
number of incomplete records with a total float less than a predetermined amount of time, and
number of records with a predecessor not having a finish-to-start relationship.

2. A method of evaluating schedule data, comprising:
filtering schedule data to identify a grouping of records, the grouping associated with a measurable parameter;
calculating at least one reportable parameter indicative of the quality of the schedule data for the grouping of records; and
performing a qualitative assessment of the schedule data based upon the calculation of the at least one reportable parameter.

3. The method of claim 2 wherein calculating the least one reportable parameter for the grouping of records comprises:
calculating a count for the grouping of records; and
translating the count into a statistical measure of the measurable parameter.

4. The method of claim 2, wherein performing the qualitative assessment of the schedule data comprises comparing the at least one reportable parameter to at least one corresponding threshold value.

5. The method of claim 4, wherein the at least one corresponding threshold value is associated with one or more schedules of a known quality level.

6. The method of claim 2, wherein performing the qualitative assessment of the schedule data comprises assigning a rating to the at least one reportable parameter.

7. The method of claim 2, wherein the schedule data comprises at least one selected from a group consisting of tasks, milestones, and summaries.

8. The method of claim 2, wherein the measurable parameter is selected from a group consisting of:
number of records comprising a summary,
number of records comprising a milestone,
number of records comprising an incomplete task,
number of records without a successor,
number of records with a predecessor,
number of records with a duration of less than a predetermined amount of time,
number of records that are not scheduled forward,
number of records with a lag of more than a predetermined amount of time,
number of records that are not as soon as possible,
number of incomplete records without a baseline finish,
number of incomplete records without resources,
number of incomplete records with a total float less than a predetermined amount of time,
number of records with a predecessor not having a finish-to-start relationship,
number of records comprising incomplete critical tasks,
number of records without Work Breakdown Structure (WBS),
number of records comprising Level of Effort (LOE) tasks,
number of records not started with predecessors that are 100% completed,
number of records with an actual start date and an actual finish date in the future,
number of records with an actual finish date that is earlier than an actual start date, and
number of records comprising a summary with one or more resources.

9. The method of claim 2, further comprising presenting the at least one reportable parameter to the user on a graphical user interface screen.

10. The method of claim 2, further comprising generating a printed report.

11. A system for evaluating schedule data, comprising:
a database storing schedule data associated with at least one schedule;
a filter manager operable to:
filter the schedule data to identify a grouping of records, the grouping of records associated with a measurable parameter;
calculate at least one reportable parameter indicative of the quality of the schedule data for the grouping of records; and
perform a qualitative assessment of the schedule data based upon the calculation of the at least one reportable parameter.

12. The system of claim 11 wherein the filter manager is operable to calculate the least one reportable parameter for the grouping of records by:
calculating a count for the grouping of records; and
translating the count into a statistical measure of the measurable parameter.

13. The system of claim 11, wherein the filter manager is operable to perform the qualitative assessment of the schedule data by comparing the at least one reportable parameter to at least one corresponding threshold value.

14. The system of claim 13, wherein the at least one corresponding threshold value is associated with one or more schedules of a known quality level.

15. The system of claim 11, wherein the filter manager is operable to perform the qualitative assessment of the schedule data by assigning a rating to the at least one reportable parameter.

16. The system of claim 11, wherein the schedule data comprises at least one selected from a group consisting of tasks, milestones, and summaries.

17. The system of claim 11, wherein the measurable parameter is selected from a group consisting of:
number of records comprising a summary,
number of records comprising a milestone,
number of records comprising an incomplete task,
number of records without a successor,
number of records with a predecessor,
number of records with a duration of less than a predetermined amount of time,
number of records that are not scheduled forward,
number of records with a lag of more than a predetermined amount of time,
number of records that are not as soon as possible,
number of incomplete records without a baseline finish,
number of incomplete records without resources,
number of incomplete records with a total float less than a predetermined amount of time,
number of records with a predecessor not having a finish-to-start relationship,
number of records comprising incomplete critical tasks,
number of records without Work Breakdown Structure (WBS),
number of records comprising Level of Effort (LOE) tasks,
number of records not started with predecessors that are 100% completed,
number of records with an actual start date and an actual finish date in the future,
number of records with an actual finish date that is earlier than an actual start date, and
number of records comprising a summary with one or more resources.

18. The system of claim 11, further comprising a screen manager operable to present the at least one reportable parameter to the user on a graphical user interface screen.

19. The system of claim 11, further comprising a report manager operable to generate a printed report.

20. Logic for evaluating schedule data, the logic embodied in a computer-readable medium and operable to:
filter schedule data to identify a grouping of records, the grouping associated with a measurable parameter;
calculate at least one reportable parameter indicative of the quality of the schedule data for the grouping of records; and
perform a qualitative assessment of the schedule data based upon the calculation of the at least one reportable parameter.
